(19) United States
(12) Patent Application Publication
(10) Pub. No.: US 2026/0358030 A1
(43) Pub. Date: Nov. 12, 2026

(54) AIR-CONDITIONING APPARATUS

(71) Applicant: Mitsubishi Electric Corporation, Tokyo (JP)

(72) Inventors: Takanori KOIKE, Tokyo (JP); Kazuyoshi SHINOZAKI, Tokyo (JP)

(21) Appl. No.: 19/122,596

(22) PCT Filed: Dec. 23, 2022
(86) PCT No.: PCT/JP2022/047500

§ 371 Date: Apr. 18, 2025

(51) Int. Cl. F25B 47/02; F25B 41/30; F25B 43/00; G01K 3/00; G01K 3/08

(52) U.S. Cl. CPC F25B 47/025; F25B 41/30; F25B 43/006; G01K 3/005; G01K 3/08; F25B 2700/1931; F25B 2700/1933; F25B 2700/21151; F25B 2700/21152

(57) ABSTRACT

In an air-conditioning apparatus, a controller is configured to upon defrosting operation, switch a flow switching device so that refrigerant discharged from a compressor flows into a heat source-side heat exchanger and fully close an expansion device, and, after returning from defrosting operation to operation, perform a first determining process to determine if: a difference between a discharge temperature and a condensing temperature is equal to or greater than a first threshold value; and a difference between an inlet temperature and an evaporating temperature is equal to or greater than a second threshold value, and, if a condition of the first determining process is not satisfied, reduce an opening degree of the expansion device.

### TECHNICAL FIELD

The present disclosure relates to an air-conditioning apparatus that can perform defrosting operation.

### BACKGROUND ART

In the past, an air-conditioning apparatus has been proposed that is configured to defrost a heat exchanger of an outdoor unit when frost deposits on the heat exchanger during heating operation (see, for example, Patent Literature 1).

In Patent Literature 1, if a request for defrosting is made to any of a plurality of heat exchangers of outdoor units during heating operation, a flow switching mechanism is switched only for a heat exchanger, for which defrosting is requested, of the plurality of heat exchangers, and high-temperature refrigerant discharged from a compressor is directly supplied to the heat exchanger for which defrosting is requested.

### CITATION LIST

### Patent Literature

Patent Literature 1: Japanese Patent No. 5029001

### SUMMARY OF INVENTION

### Technical Problem

In Patent Literature 1, during defrosting operation, an expansion device of each indoor unit is open, so that liquid refrigerant accumulated in a heat exchanger of the indoor unit during heating operation flows into the outdoor unit through the expansion device of the indoor unit. If the amount of liquid refrigerant flowing into the outdoor unit is large, the liquid refrigerant flows back into the compressor of the outdoor unit.

An air conditioning apparatus of the present disclosure was made to overcome the above problems, and one object of the present disclosure is to provide an air-conditioning apparatus that can suppress liquid backflow to a compressor.

### Solution to Problem

The air-conditioning apparatus of the present disclosure is an air-conditioning apparatus including: an outdoor unit including a compressor, a flow switching device, a heat source-side heat exchanger, and an accumulator; an indoor unit including an expansion device and a load-side heat exchanger a relay unit connected between the outdoor unit and the indoor unit, and configured to switch a flow of refrigerant depending on an operation state; the outdoor unit, the relay unit, and the indoor unit being connected by pipes, to form a refrigerant circuit in which the refrigerant circulates, a controller configured to control the refrigerant circuit; a discharge temperature detecting device configured to detect a temperature of the refrigerant discharged from the compressor; a discharge pressure detecting device configured to detect a pressure of the refrigerant discharged from the compressor; and an inlet temperature detecting device configured to detect the temperature of the refrigerant flowing into the accumulator, and a suction pressure detecting device configured to detect the pressure of the refrigerant suctioned by the compressor, the controller is configured to upon defrosting operation, switch the flow switching device so that the refrigerant discharged from the compressor flows into the heat source-side heat exchanger and fully close the expansion device, and, after returning from the defrosting operation to the heating operation, perform a first determining process to determine if: a difference between a temperature detected by the discharge temperature detecting device and a condensing temperature converted from a pressure detected by the discharge pressure detecting device is equal to or greater than a first threshold value, which is a preset value; and a difference between a temperature detected by the inlet temperature detecting device and an evaporating temperature converted from a pressure detected by the suction pressure detecting device is equal to or greater than a second threshold value, which is a preset value, and, if a condition of the first determining process is not satisfied, reduce an opening degree of the expansion device.

### Advantageous Effects of Invention

According to an embodiment of the air-conditioning apparatus of the present disclosure, the controller is configured to switch the flow switching device so that the refrigerant discharged from the compressor flows into the heat source-side heat exchanger and fully close the expansion device, and after returning from the defrosting operation to the heating operation, perform a first determining process to determine if an excessive amount of liquid refrigerant returns to the outdoor unit. If the conditions of the first determining process are not satisfied, the controller reduces the opening degree of the expansion device. In this way, by fully closing the expansion device of the indoor unit during defrosting operation, the liquid refrigerant accumulated in the indoor unit does not flow to the outdoor unit, so that the liquid backflow to the compressor can be suppressed. Furthermore, if an excessive amount of liquid refrigerant returns from the indoor unit to the outdoor unit after the apparatus's returning from defrosting operation to heating operation, by reducing the opening degree of the expansion device of the indoor unit, the air-conditioning apparatus can prevent an excessive amount of the liquid refrigerant from returning from the indoor unit to the outdoor unit, to prevent liquid backflow to the compressor.

### BRIEF DESCRIPTION OF DRAWINGS

FIG. 1 is a schematic diagram showing an example of the refrigerant circuit configuration of an air-conditioning apparatus according to an embodiment.

FIG. 2 is a schematic diagram to explain the flow of refrigerant in the air-conditioning apparatus shown in FIG. 1 during cooling-only operation.

FIG. 3 is a schematic diagram to explain the flow of refrigerant during cooling-main operation in the air-conditioning apparatus shown in FIG. 1.

FIG. 4 is a schematic diagram to explain the flow of refrigerant in the air-conditioning apparatus shown in FIG. 1 during heating-only operation.

FIG. 5 is a schematic diagram to explain the flow of refrigerant during heating-main operation in the air-conditioning apparatus shown in FIG. 1.

FIG. 6 is a schematic diagram to explain the flow of refrigerant during defrosting operation in the air-conditioning apparatus shown in FIG. 1.

FIG. 7 is a flowchart showing a control process of the air-conditioning apparatus after the air-conditioning apparatus returns from defrosting operation to heating operation.

### DESCRIPTION OF EMBODIMENTS

The following describes an embodiment of the present disclosure with reference to drawings. The present disclosure is not limited by the embodiment described below. The dimensional relationships between components in the accompanying drawings may differ from those of the actual ones.

### Embodiment

An air-conditioning apparatus 100 according to one embodiment is described. In the following explanation, the air-conditioning apparatus 100 is installed in, for example, a building or an apartment building, and can perform cooling operation or heating operation using a refrigerant circuit 101 in which refrigerant circulates. In particular, the air-conditioning apparatus 100 according to the embodiment can perform cooling-only operation, heating-only operation, or simultaneous cooling and heating operation for a plurality of air-conditioning target spaces. Furthermore, the air-conditioning apparatus 100 according to the embodiment can perform defrosting operation to remove frost depositing on the heat source-side heat exchanger 13 during the heating operation.

### [Configuration of Air-Conditioning Apparatus 100]

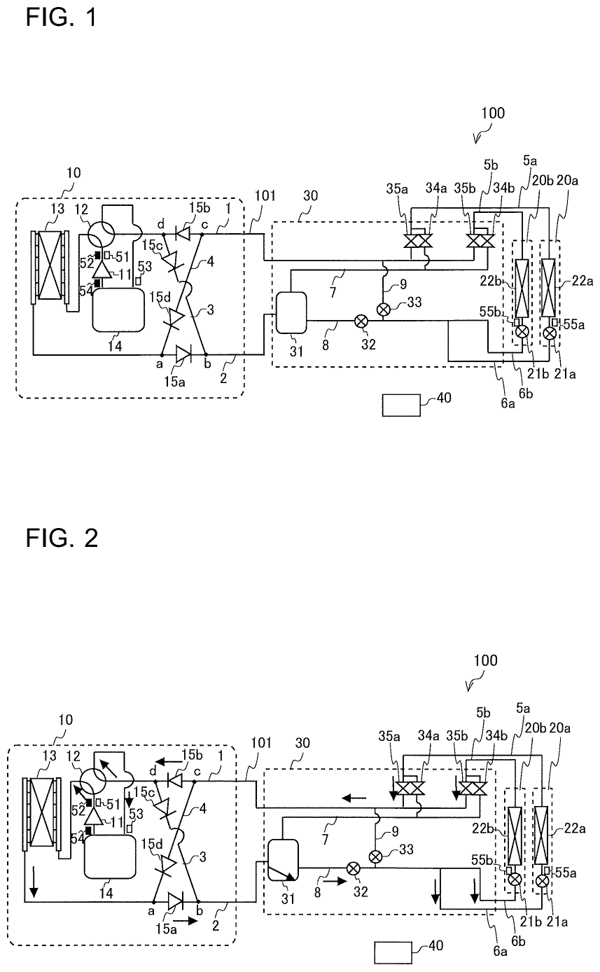

FIG. 1 is a schematic diagram showing an example of the refrigerant circuit configuration of the air-conditioning apparatus 100. The air-conditioning apparatus 100 includes an outdoor unit 10, a plurality of indoor units 20a and 20b, a relay unit 30, and a controller 40. In the example shown in FIG. 1, the air-conditioning apparatus 100 includes one outdoor unit 10, two indoor units 20a and 20b, and one relay unit 30.

In the air-conditioning apparatus 100, the outdoor unit 10 and the relay unit 30 are connected by a first main pipe 1 and a second main pipe 2. The relay unit 30 is connected to the indoor unit 20a by a first branch pipe 5a and a second branch pipe 6a. The relay unit 30 is also connected to the indoor unit 20b by a first branch pipe 5b and a second branch pipe 6b. In this way, the outdoor unit 10, the relay unit 30, and the indoor units 20a and 20b are connected with their corresponding pipes to form the refrigerant circuit 101 in which the refrigerant circulates. The number of indoor units 20a and 20b are not limited to the above configuration as an example, but may be three or more. Also, two or more outdoor units 10 and/or two or more relay units 30 may be provided, for example. Furthermore, the type of refrigerant used in the air-conditioning apparatus 100 is not limited. Natural refrigerants such as carbon dioxide, hydrocarbons, helium, etc., or chlorine-free alternatives such as HFC410A, HFC407C, HFC404A, or CFC-based refrigerants such as R22 or R134a used in existing products, may be used.

### (Outdoor Unit 10)

The outdoor unit 10 is provided to supply heat to the indoor unit 20. The outdoor unit 10 has a compressor 11, a flow switching device 12, a heat source-side heat exchanger 13, and an accumulator 14. Furthermore, the outdoor unit 10 includes a check valve 15a, a check valve 15b, a check valve 15c, a check valve 15d, a first valve 15d, a first connection pipe 3, and a second connection pipe 4, so that the flow of refrigerant into relay unit 30 is constant, regardless of the requirements of indoor unit 20.

The compressor 11 suctions a low-temperature, low-pressure gas refrigerant, compresses the refrigerant to a high-temperature, high-pressure state, and discharges it. For example, an inverter compressor that can control the capacity, which is the amount of refrigerant delivered per unit time, by freely changing the driving frequency is used as the compressor 11. The driving frequency of compressor 11 is controlled by the controller 40.

Note that compressor 11 is not limited to an inverter type, but may be, for example, a constant-speed type compressor, or a compressor that combines an inverter type and a constant-speed type. The compressor 11 may be of any type that can compress the suctioned refrigerant to a high pressure condition, such as reciprocating, rotary, scroll, or screw compressors.

The flow switching device 12 is, for example, a four-way valve that switches between the cooling operation and the heating operation by switching the refrigerant flow direction. The switching of flow switching device 12 is controlled by controller 40. The flow switching device 12 is not limited to this example. For example, the flow switching device may be a combination of valves of other types, such as a 2-way valve or a 3-way valve.

The heat source-side heat exchanger 13 exchanges heat between a fluid, such as outdoor air or water, and the refrigerant. Specifically, the heat source-side heat exchanger 13 serves as a condenser that dissipates heat from the refrigerant to outdoor air during cooling operation, causing the refrigerant to condense and liquefy. In addition, the heat source-side heat exchanger 13 serves as an evaporator that evaporates the refrigerant and turns it into gas during heating operation, and absorbs heat from the outdoor air as vaporization heat.

If the heat source-side heat exchanger 13 is an air-cooled heat exchanger, the outdoor unit 10 is provided with a fan, not shown in the figure, such as a heat source-side fan, provided to supply outdoor air to the heat source-side heat exchanger 13. The rotation speed of the heat source-side fan is controlled by the controller 40 to control the condensation capacity or evaporation capacity of the heat source-side heat exchanger 13.

When the heat source-side heat exchanger 13 is a water-cooled heat exchanger, a water circulation pump, not shown in the figure, is installed in the outdoor unit 10 to circulate a fluid such as water to be supplied to the heat source-side heat exchanger 13. The rotation speed of the water circulation pump is controlled by the controller 40 to control the condensation capacity or evaporation capacity of the heat source-side heat exchanger 13.

The accumulator 14 is installed on the low-pressure side, which is the suction side of the compressor 11. The accumulator 14 stores the excess refrigerant generated by the difference in operating conditions between the cooling operation and the heating operation, as well as the excess refrigerant for transient changes in operation.

The first connection pipe 3 connects the second main pipe 2 on the downstream side of check valve 15a with the first main pipe 1 on the downstream side of the check valve 15b. The second connection pipe 4 connects the second main pipe 2 on the upstream side of the check valve 15a with the first main pipe 1 on the upstream side of check valve 15b. A merging portion between the second connection pipe 4 and the second main pipe 2 is called a merging portion a, and a merging portion between the first connection pipe 3 and the second main pipe 2 is called a merging portion b (downstream of the merging portion a). A merging portion between the second connection pipe 4 and the first main pipe 1, is called a merging portion c, and a merging portion between the first connection pipe 3 and the first main pipe 1 is called a merging portion d (downstream of merging portion c). The merging portions a, b, c, and d are shown in the drawings.

The check valve 15a is located between the merging portion a and the merging portion b and allows the refrigerant to flow only in the direction from outdoor unit 10 to relay unit 30. The check valve 15b is located between the merging portion c and the merging portion d and allows the refrigerant to flow only in the direction from the relay unit 30 to the outdoor unit 10. The check valve 15c is located at the first connection pipe 3 and allows the refrigerant to flow only in the direction from the merging portion d to the merging portion b. The check valve 15d is located at the second connection pipe 4 and allows the refrigerant to flow only in the direction from the merging portion c to the merging portion a.

### (Indoor Units 20a and 20b)

Each of the indoor units 20a and 20b provides heat from the outdoor unit 10 to a cooling load or a heating load, and perform cooling or heating for the air-conditioning target space. The indoor unit 20a includes an expansion device 21a and a load-side heat exchanger 22a. The indoor unit 20b includes an expansion device 21b and a load-side heat exchanger 22b.

In the following explanation, the indoor unit 20a and the indoor unit 20b will be referred to simply as “indoor unit 20” appropriately when no particular distinction between them is needed. Since the expansion device 21a and the expansion device 21b have the same configuration, and the load-side heat exchanger 22a and the load-side heat exchanger 22b have the same configuration, the expansion device 21a and the load-side heat exchanger 22a are explained in the following as an example.

The expansion device 21a serves as a pressure reducing valve and an expansion valve to depressurize and expand the refrigerant by adjusting the flow rate of the refrigerant. The expansion device 21a comprises a valve that has a controllable opening degree, such as, an electronic expansion valve. In this case, the opening degree of the expansion device 21a is controlled by the controller 40.

The load-side heat exchanger 22a exchanges heat between the refrigerant and a fluid such as indoor air or water. Specifically, during cooling operation, the load-side heat exchanger 22a serves as an evaporator to evaporate the refrigerant, turning it into gas, and absorbing heat from the outdoor air as vaporization heat. In addition, the load-side heat exchanger 22a serves as a condenser that dissipates the heat of the refrigerant to the indoor air during the heating operation to condense the refrigerant and liquefy it.

The indoor unit 20a is provided with a fan, such as a load-side fan not shown in the figure, configured to supply indoor air to the load-side heat exchanger 22a. The evaporation capacity or condensation capacity of the load-side heat exchanger 22a is controlled by controlling the rotation speed of the load-side fan by the controller 40.

### (Relay Unit 30)

The relay unit 30 switches the flow of refrigerant depending on the operation state so that the low-temperature refrigerant is distributed to the indoor unit 20 that performs the cooling operation and the high-temperature refrigerant is distributed to the indoor unit 20 that performs the heating operation.

The relay unit 30 includes a gas-liquid separator 31, a first expansion device 32, a second expansion device 33, first valves 34a and 34b, and second valves 35a and 35b. In the following description, the first valves 34a and 34b and the second valves 35a and 35b will be referred to simply as “the first valve 34” and “the second valve 35” when no particular distinction is necessary.

The relay unit 30 includes a connection pipe 7, a connection pipe 8, and a relay pipe 9. The connection pipe 7 connects the gas side of the gas-liquid separator 31 with the first valve 34 and is the pipe through which the gas refrigerant flows. The connection pipe 8 connects the liquid side of the gas-liquid separator 31 with the in-door unit 20, and is the pipe through which the liquid refrigerant flows. The relay pipe 9 is provided at the relay connection pipe 7 and the connection pipe 8.

The gas-liquid separator 31 is provided at the second main pipe 2, and the connection pipe 7 and the connection pipe 8 are connected to the gas-liquid separator 31. The gas-liquid separator 31 separates the two-phase refrigerant flowing through the second main pipe 2 into gas refrigerant and liquid refrigerant. The gas refrigerant separated by the gas-liquid separator 31 is fed to the first valve 34 via the connection pipe 7. The liquid refrigerant separated by the gas-liquid separator 31 is fed to the first expansion device 32 via the connection pipe 8.

The first expansion device 32 is installed at the connection pipe 8. The first expansion device 32 serves as a pressure reducing valve and an expansion valve to depressurize and expand the refrigerant by adjusting the flow rate of the refrigerant. The first expansion device 32 comprises a valve that can control the opening degree, for example, an electronic expansion valve. In this case, the opening degree of the first expansion device 32 is controlled by the controller 40.

The second expansion device 33 is installed at the relay pipe 9. The second expansion device 33 serves as a pressure reducing valve and an expansion valve to depressurize and expand the refrigerant by adjusting the flow rate of the refrigerant. The second expansion device 33 comprises a valve that has a controllable opening degree, such as, an electronic expansion valve. In this case, the opening degree of the second expansion device 33 is controlled by controller 40.

The first valves 34a and 34b are configured to control the supply of refrigerant to the indoor units 20a and 20b in each operating mode, and are installed between the connection pipe 7 and the first branch pipes 5a and 5b. In other words, the first valve 34a and the first valve 34b are connected to the gas-liquid separator 31 on one side, and the load-side heat exchangers 22a and 22b of the indoor units 20a and 20b on the other side, and their opening and closing are controlled so that the refrigerant is allowed to conduct or not to conduct depending on the opening and the closing.

The second valves 35a and 35b are also configured to control the supply of refrigerant to the indoor units 20a and 20b in each operating mode, and are installed between the first branch pipes 5a and 5b and the first main pipe 1. In other words, the second valves 35a and 35b are connected to the first main pipe 1 on one side and connected to the load-side heat exchangers 22a and 22b of the indoor unit 20a and 20b and on the other side. The refrigerant is allowed to conduct or not to conduct depending on the opening and the closing.

### (Controller 40)

The controller 40 is configured to control the entire air-conditioning apparatus 100. For example, the controller 40 controls the components, such as, the flow switching device 12, the expansion devices 21a and 21b, the first expansion device 32, the second expansion device 33, the first valves 34a and 34b, and the second valve 35a and 35b., depending on the operation mode of air-conditioning apparatus 100. The controller 40 is a microcomputer or any other computing device on which various functions are implemented by executing software. Alternatively, the controller 40 may be hardware such as a circuit device that achieves various functions.

The above refrigerant circuit 101 includes a discharge temperature detecting device 51, a discharge pressure detecting device 52, an inlet temperature detecting device 53, a suction pressure detecting device 54, and a condenser outlet temperature detecting devices 55a and 55b. The discharge temperature detecting device 51 is installed on the discharge side of the compressor 11 and detects the temperature of the refrigerant discharged from the compressor 11. The discharge pressure detecting device 52 is installed on the discharge side of the compressor 11 and detects the pressure of the refrigerant discharged from compressor 11. The inlet temperature detecting device 53 is installed on the inlet side of the accumulator 14 and detects the temperature of the refrigerant flowing in the accumulator 14. The suction pressure detecting device 54 is installed on the suction side of the compressor 11 and detects the pressure of the refrigerant suctioned by the compressor 11. The suction pressure detecting device 54 may be installed in the inlet of the accumulator 14. The condenser outlet temperature detecting devices 55a and 55b are provided at the outlet of the load-side heat exchangers 22a and 22b when they serve as condensers and detect the temperature of the refrigerant flowing out when the load-side heat exchanger 22a and 22b serve as condensers. The discharge temperature detecting device 51, the inlet temperature detecting device 53, and the condenser outlet temperature detecting devices 55a and 55b are, for example, thermistors. The discharge pressure detecting device 52 and the suction pressure detecting device 54 are, for example, pressure gauges.

### [Refrigerant Operation of Air-Conditioning Apparatus 100]

Next, the operation of the refrigerant in various operation modes in the air-conditioning apparatus 100 with the above configuration is described. The air-conditioning apparatus 100 has the following operation modes: cooling-only operation, cooling-main operation, heating-only operation, heating-main operation, and defrosting operation. The air-conditioning apparatus performs any of the operations.

The cooling-only operation is a type of cooling operation in which all the indoor units 20 perform cooling for the air-conditioning target space. The cooling-main operation is a type of cooling operation that is performed when the cooling load of the indoor units 20 performing cooling for the air-conditioning target space exceeds the heating load of the indoor units 20 performing cooling for the air-conditioning target space. Heating only operation is a type of heating operation in which all the indoor units 20 perform heating for the air-conditioning target space. The heating-main operation is a type of heating operation that is performed when the heating load of the indoor units 20 performing cooling for the air-conditioning target space exceeds the cooling load of the indoor units 20 performing cooling for the air-conditioning target space. The defrosting operation is performed to remove frost depositing on the heat source-side heat exchanger 13 during heating operation (heating-only operation or heating-main operation).

### (Cooling Only Operation)

FIG. 2 is a schematic diagram to explain the flow of refrigerant in the cooling-only operation of the air-conditioning apparatus 100 shown in FIG. 1. In the cooling-only operation, all the indoor units 20a and 20b perform cooling for the air-conditioning target space. In FIG. 2, the flow direction during the cooling-only operation is indicated by arrows.

In the cooling-only operation, the flow switching device 12 in the outdoor unit 10 is switched so that the discharge side of the compressor 11 is connected to the heat source-side heat exchanger 13 and the suction side of the compressor 11 is connected to first main pipe 1. The first valves 34a and 34b are closed and the second valves 35a and 35b are opened.

The low-temperature, low-pressure refrigerant is compressed by the compressor 11 and discharged as high-temperature, high-pressure gas refrigerant. The high-temperature, high-pressure gas refrigerant discharged from the compressor 11 flows into the heat source-side heat exchanger 13 via the flow switching device 12. The high-temperature, high-pressure gas refrigerant that flows into the heat source-side heat exchanger 13 exchanges heat with the outdoor air and condenses while dissipating heat. By thus dissipating heat, the refrigerant becomes high-pressure liquid refrigerant and flows out of the heat source-side heat exchanger 13. The high-pressure liquid refrigerant flowing out of the heat source-side heat exchanger 13 passes through the second main pipe 2, flows out of the outdoor unit 10, and flows into the relay unit 30.

The high-pressure liquid refrigerant that flows into the relay unit 30 flows through the gas-liquid separator 31 into the first expansion device 32, where it is depressurized and expanded to become intermediate-pressure liquid refrigerant. The intermediate-pressure liquid refrigerant at the then passes through the connection pipe 8, is divided into the second branch pipes 6a and 6b, and flows out of relay unit 30. The intermediate-pressure liquid refrigerant flowing out of the relay unit 30 passes through the second branch pipes 6a and 6b and flows into the indoor units 20a and 20b.

The liquid refrigerant of intermediate pressure that flows into the indoor unit 20a is depressurized and expanded by the expansion device 21a to become a low-temperature, low-pressure two-phase gas-liquid refrigerant. The low-temperature, low-pressure, two-phase gas-liquid refrigerant that flows into the load-side heat exchanger 22a cools the indoor air by exchanging heat with the indoor air, absorbing heat therefrom and evaporating, and then flows out of the load-side heat exchanger 22a as a low pressure gas refrigerant. The low-pressure gas refrigerant flowing out of the load-side heat exchanger 22a passes through the first branch pipe 5a, flows out of the indoor unit 20a, and flows into the relay unit 30.

The intermediate-pressure liquid refrigerant that flows into the indoor unit 20b becomes a low-pressure gas refrigerant through the expansion device 21b and the load-side heat exchanger 22b, in the same way as the refrigerant that flows into the indoor unit 20a. The low-pressure gas refrigerant then flows out of the indoor unit 20b through the first branch pipe 5b and flows into the relay unit 30.

The low-pressure gas refrigerant flowing into the relay unit 30 reaches the first main pipe 1 via the second valves 35a and 35b, flows out of the relay unit 30, and then flows into the outdoor unit 10. The low-pressure gas refrigerant that flows into the outdoor unit 10 passes through the flow switching device 12 and the accumulator 14 and is suctioned into compressor 11. Then, the above-mentioned circulation is repeated.

### (Cooling Main Operation)

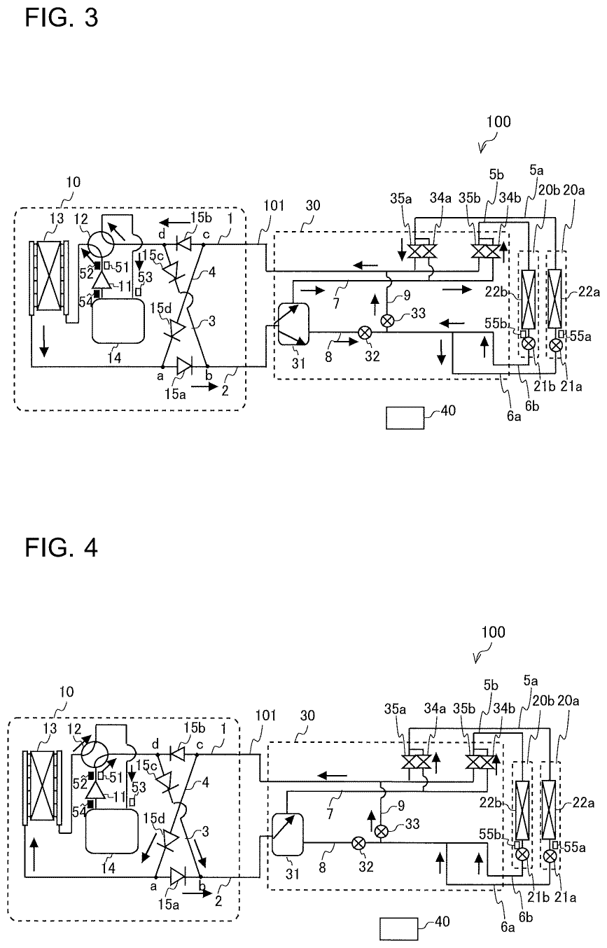

FIG. 3 is a schematic diagram to explain the flow of refrigerant during the cooling-main operation in the air-conditioning apparatus 100 shown in FIG. 1. Here, the case is described in which the indoor unit 20a performs cooling for the air-conditioning target space and the indoor unit 20b performs heating for the air-conditioning target space is taken as an example. In FIG. 3, the flow direction of the refrigerant during the cooling-main operation is indicated by arrows.

In the cooling-main operation, the flow switching device 12 in the outdoor unit 10 is switched so that the discharge side of the compressor 11 is connected to heat source-side heat exchanger 13 and the suction side of compressor 11 is connected to the first main pipe 1. The first valve 34a and the second valve 35b are closed, and the first valve 34b and the second valve 35a are opened.

The low-temperature, low-pressure refrigerant is compressed by the compressor 11 and discharged as high-temperature, high-pressure gas refrigerant. The high-temperature, high-pressure gas refrigerant discharged from the compressor 11 flows into the heat source-side heat exchanger 13 via the flow switching device 12. The high-temperature, high-pressure gas refrigerant that flows into the heat source-side heat exchanger 13 exchanges heat with the outdoor air and condenses while dissipating heat. The high-temperature, high-pressure gas refrigerant that flows into the heat source-side heat exchanger 13 condenses with outdoor air and becomes high-pressure, two-phase gas-liquid refrigerant, which flows out of the heat source-side heat exchanger 13. The high-pressure two-phase gas-liquid refrigerant flowing out of the heat source-side heat exchanger 13 flows through the second main pipe 2, flows out of the outdoor unit 10, and flows into the relay unit 30.

The high-pressure two-phase gas-liquid refrigerant that flows into the relay unit 30 flows into the gas-liquid separator 31 and is separated into the high-pressure gas refrigerant and the high-pressure liquid refrigerant. The high-pressure gas refrigerant separated by the gas-liquid separator 31 passes through the connection pipe 7, then passes through the first valve 34b to pass through the first branch pipe 5b, and then flows out of the relay unit 30. The high-pressure gas refrigerant flowing out of the relay unit 30 flows into the indoor unit 20b.

The high-pressure gas refrigerant flowing into the indoor unit 20b flows into the load-side heat exchanger 22b, exchanges heat with indoor air, and condenses while dissipating heat to heat the indoor air, become a high-pressure liquid refrigerant and flow out of the load-side heat exchanger 22b. The high-pressure liquid refrigerant flowing out of the load-side heat exchanger 22b is depressurized and expanded by the expansion device 21b to become an intermediate-pressure liquid refrigerant, which flows out of the indoor unit 20b and then flows into the relay unit 30.

The liquid refrigerant of intermediate pressure flowing into the relay unit 30 passes through the second branch pipe 6b and then splits, one of which passes through the second branch pipe 6a and flows out of the relay unit 30. The liquid refrigerant of intermediate pressure flowing out of the relay unit 30 flows into the indoor unit 20a.

The liquid refrigerant of intermediate pressure that flows into the indoor unit 20a is depressurized and expanded by the expansion device 21a to become low-temperature, low-pressure two-phase gas-liquid refrigerant. The low-temperature, low-pressure, two-phase gas-liquid refrigerant that flows into the load-side heat exchanger 22a The low-temperature, low-pressure, two-phase gas-liquid refrigerant that flows into the load-side heat exchanger 22a cools the indoor air by exchanging heat with the indoor air, absorbing heat therefrom and evaporating, and then flows out from the load-side heat exchanger 22a as a low-pressure gas refrigerant. The low-pressure gas refrigerant flowing out of the load-side heat exchanger 22a passes through the first branch pipe 5a, flows out of the indoor unit 20a, and slows into the relay unit 30. The low-pressure gas refrigerant flowing into the relay unit 30 reaches the first main pipe 1 via the second valve 35a.

On the other hand, the high-pressure liquid refrigerant separated by the gas-liquid separator 31 passes through the connection pipe 8 and then flows into the first expansion device 32, where it is depressurized and expanded to become intermediate pressure liquid refrigerant. The intermediate-pressure liquid refrigerant that flows out of the first expansion device 32 merges with the intermediate-pressure liquid refrigerant that is diverted after flowing into the relay unit 30 from the indoor unit 20b, and passes through the relay pipe 9. The intermediate pressure liquid refrigerant that passes through the relay pipe 9 is depressurized and expanded by the second expansion device 33 to become low-pressure liquid refrigerant. The low-pressure liquid refrigerant then reaches the first main pipe 1, merges with the low-pressure gas refrigerant passing through the first main pipe 1 via the second valve 35a, and flows out of the relay unit 30.

The low-pressure refrigerant flowing out of the relay unit 30 flows into the outdoor unit 10 via the first main pipe 1. The low-pressure refrigerant flowing into the outdoor unit 10 passes through the flow switching device 12 and the accumulator 14, and is suctioned to the compressor 11. Then, the above-mentioned circulation is repeated.

### (Heating Only Operation)

FIG. 4 is a schematic diagram to explain the flow of refrigerant in the heating-only operation of the air-conditioning apparatus 100 shown in FIG. 1. In the heating-only operation, all the indoor units 20a and 20b perform heating for the air-conditioning target space. In FIG. 4, the direction of the refrigerant flow in heating-only operation is indicated by arrows.

In the heating-only operation, the flow switching device 12 in the outdoor unit 10 is switched so that the discharge side of the compressor 11 is connected to the first main pipe 1 and the suction side of the compressor 11 is connected to the heat source-side heat exchanger 13. The first valves 34a and 34b are opened and the second valves 35a and 35b are closed. In addition, the first expansion device 32 is fully closed and the second expansion device 33 is fully opened.

The low-temperature, low-pressure refrigerant is compressed by the compressor 11 and discharged as high-temperature, high-pressure gas refrigerant. The high-temperature, high-pressure gas refrigerant discharged from the compressor 11 is then passes through the flow switching device 12, the first main pipe 1, the first connection pipe 3, and the second main pipe 2, and flows out of the outdoor unit 10 and into the relay unit 30. The high-temperature, high-pressure gas refrigerant flowing into the relay unit 30 passes through the first branch pipes 5a and 5b via the gas-liquid separator 31, the connection pipe 7, and the first valves 34a and 34b, and then flows out of the relay unit 30 and into the indoor units 20a and 20b.

The high-temperature, high-pressure gas refrigerant that flows into the indoor unit 20a flows into the load-side heat exchanger 22a and heats the indoor air by exchanging heat with the indoor air and dissipating heat and condensing. The high-temperature, high-pressure gas refrigerant thereby becomes high-pressure liquid refrigerant and flows out of the load-side heat exchanger 22a. The high-pressure liquid refrigerant flowing out of the load-side heat exchanger 22a is depressurized and expanded by the expansion device 21a to become a low-pressure liquid refrigerant, flows out of the indoor unit 20a, and then flows into the relay unit 30 through the second branch pipe 6a.

The high-temperature, high-pressure gas refrigerant flowing into the indoor unit 20b becomes low-pressure liquid refrigerant by flowing through the load-side heat exchanger 22b and the expansion device 21b in the same way as the refrigerant flowing into the indoor unit 20a. The low-pressure liquid refrigerant flows into the relay unit 30 through the second branch pipe 6b after flowing out of the indoor unit 20b.

The low-pressure liquid refrigerant flowing into the relay unit 30 flows out of the relay unit 30 via the second expansion device 33 and the first main pipe 1. The low-pressure liquid refrigerant flowing out of the relay unit 30 flows into the outdoor unit 10 via the first main pipe 1. The low-pressure liquid refrigerant flowing into the outdoor unit 10 flows into heat source-side heat exchanger 13 via the second connection pipe 4 and the second main pipe 2. The low-pressure liquid refrigerant that flows into the heat source-side heat exchanger 13 exchanges heat with the outdoor air, absorbs heat, and evaporates to become low-temperature, low-pressure gas refrigerant, which flows out of the heat source-side heat exchanger 13. The low-pressure gas refrigerant flowing out of the heat source-side heat exchanger 13 passes through the flow switching device 12 and the accumulator 14, and is suctioned into the compressor 11. Then, the above-mentioned circulation is repeated.

### (Heating Main Operation)

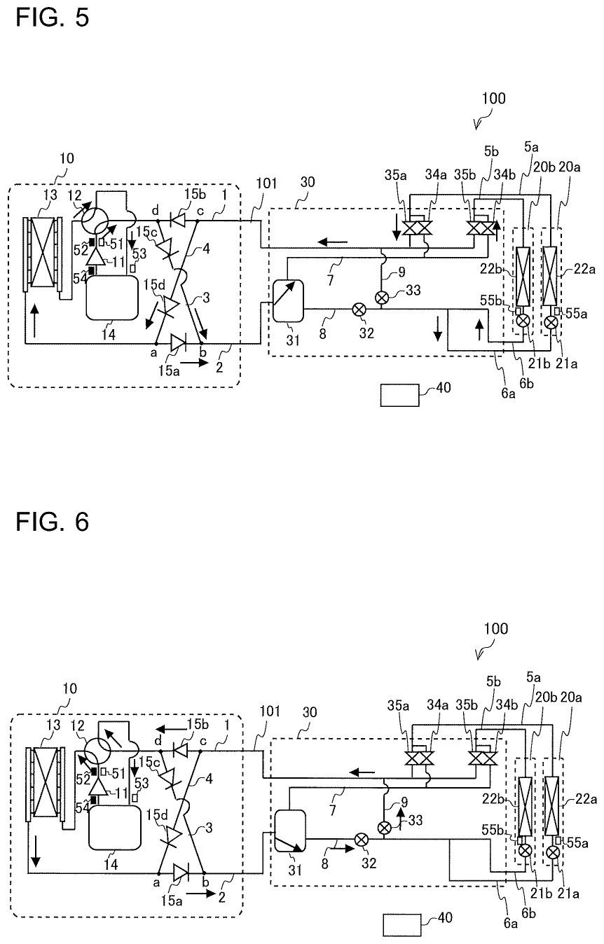

FIG. 5 is a schematic diagram to explain the flow of refrigerant during the heating-main operation in the air-conditioning apparatus 100 shown in FIG. 1. Here, the case in which the indoor unit 20b performs heating for the air-conditioning target space and the indoor unit 20a performs cooling for the air-conditioning target space is taken as an example. In FIG. 5, the flow direction of the refrigerant in the heating-main operation is indicated by arrows.

In the heating-main operation, the flow switching device 12 in the outdoor unit 10 is switched so that the discharge side of compressor 11 is connected to the first main pipe 1 and the suction side of the compressor 11 is connected to the heat source-side heat exchanger 13. The first valve 34a and the second valve 35b are closed, and the first valve 34b and the second valve 35a are opened. In addition, the first expansion device 32 and the second expansion device 33 are fully closed.

The low-temperature, low-pressure refrigerant is compressed by the compressor 11 and discharged as high temperature, high-pressure gas refrigerant. The high-temperature, high-pressure gas refrigerant discharged from the compressor 11 passes through the flow switching device 12, the first main pipe 1, the first connection pipe 3, the second main pipe 2, and flows out of the outdoor unit 10, and into the relay unit 30. The high-temperature, high-pressure gas refrigerant flowing into the relay unit 30 passes through the first branch pipe 5b via the gas-liquid separator 31, the connection pipe 7 and the first valve 34b, then flows out of the relay unit 30 and into the indoor unit 20b.

The high-temperature, high-pressure gas refrigerant that flows into the indoor unit 20b flows into the load-side heat exchanger 22b, and heats the indoor air by exchanging heat with the indoor air and dissipating heat and condensing. The high-temperature, high-pressure gas refrigerant then becomes high-pressure liquid refrigerant and flows out of the load-side heat exchanger 22b. The high-pressure liquid refrigerant flowing out of the load-side heat exchanger 22b is depressurized and expanded by the expansion device 21b to become intermediate-pressure liquid refrigerant, which flows out of the indoor unit 20b, and then passes through the second branch pipe 6a and flows into the relay unit 30.

The liquid refrigerant of intermediate pressure that flows into the relay unit 30 passes through the second branch pipe 6b, then passes through the second branch pipe 6a, and flows out of the relay unit 30. The liquid refrigerant at intermediate pressure flowing out of the relay unit 30 flows into the indoor unit 20a.

The liquid refrigerant of intermediate pressure that flows into the indoor unit 20a is depressurized and expanded by the expansion device 21a to become low-temperature, low-pressure two-phase gas-liquid refrigerant, which flows into the load-side heat exchanger 22a. The low-temperature, low-pressure, two-phase gas-liquid refrigerant that flows into the load-side heat exchanger 22a cools the indoor air by exchanging heat with the indoor air, absorbing heat and evaporating, and then flows out of the load-side heat exchanger 22a as a low-pressure gas refrigerant. The low-pressure gas refrigerant flowing out of the load-side heat exchanger 22a passes through the first branch pipe 5a, flows out of the indoor unit 20a, and flows into the relay unit 30. The low-pressure gas refrigerant flowing into the relay unit 30 passes through the second valve 35a to the first main pipe 1. The low-pressure gas refrigerant then flows out of the relay unit 30 through the first main pipe 1.

The low-pressure liquid refrigerant flowing out of the relay unit 30 flows into the outdoor unit 10 via the first main pipe 1. The low-pressure liquid refrigerant flowing into the outdoor unit 10 flows into the heat source-side heat exchanger 13 via the second connection pipe 4 and the second main pipe 2. The low-pressure liquid refrigerant that flows into heat source-side heat exchanger 13 exchanges heat with outdoor air, absorbs heat, and evaporates to become low-temperature, low-pressure gas refrigerant and flows out of the heat source-side heat exchanger 13. The low-pressure gas refrigerant flowing out of the heat source-side heat exchanger 13 passes through the flow switching device 12 and the accumulator 14, and is suctioned to the compressor 11. Then, the above-mentioned circulation is repeated.

### (Defrosting Operation)

FIG. 6 is a schematic diagram to explain the flow of refrigerant during the defrosting operation in the air-conditioning apparatus 100 shown in FIG. 1. In FIG. 6, the direction of the refrigerant flow in the defrosting operation is indicated by arrows.

In the defrosting operation, the heating operation (heating-only operation or heating-main operation) is interrupted and the flow switching device 12 in the outdoor unit 10 is switched so that the discharge side of the compressor 11 is connected to the heat source-side heat exchanger 13 and the suction side of the compressor 11 is connected to the first main pipe 1. The first valves 34a and 34b and the second valves 35a and 35b are closed. In addition, the expansion devices 21a and 21b are fully closed.

When the low-temperature, low-pressure gas refrigerant is suctioned into compressor 11, it is compressed by the compressor 11 to become high-temperature, high-pressure gas refrigerant and discharged from the compressor 11. The gas refrigerant discharged from the compressor 11 passes through the flow switching device 12 and flows into the heat source-side heat exchanger 13. The high-temperature, high-pressure gas refrigerant that flows into the heat source-side heat exchanger 13 becomes liquid refrigerant by exchanging heat with the ambient air. The heat source-side heat exchanger 13 serves as a condenser to dissipate heat to the ambient air and reduce the refrigerant temperature of the refrigerant in the pipes. Therefore, the heat dissipation of the heat source-side heat exchanger 13 into the air melts the frost depositing on the surface of the heat source-side heat exchanger 13. At this time, fans (not shown) located near the heat source-side heat exchanger 13 are often stopped. Liquid refrigerant flowing out of the heat source-side heat exchanger 13 passes through the second main pipe 2 and flows into the relay unit 30.

The refrigerant flowing into the relay unit 30 passes through the connection pipe 8, flows into the first expansion device 32, is depressurized and expanded, passes through the relay pipe 9, and is depressurized and expanded by the second expansion device 33 to become low-temperature, low-pressure gas. Then, the low-temperature, low-pressure gas refrigerant flows out of the relay unit 30 through the first main pipe 1. The low-temperature, low-pressure gas refrigerant flowing out of the relay unit 30 passes through the first main pipe 1 into the outdoor unit 10. The low-temperature, low-pressure gas refrigerant flowing into the outdoor unit 10 passes through the flow switching device 12 and the accumulator 14, and is then suctioned into compressor 11. Then, the above-mentioned circulation is repeated.

In the defrosting operation, the liquid refrigerant accumulated in the indoor units 20a and 20b is retained in the indoor units 20a and 20b because the first valves 34a and 34b and the second valves 35a and 35b are closed and the expansion devices 21a and 21b are fully closed. In other words, since the liquid refrigerant accumulated in indoor units 20a and 20b does not flow to the outdoor unit 10, the amount of inflow to the outdoor unit 10 increases, preventing the liquid refrigerant accumulated in the accumulator 14 from overflowing and flowing back into the compressor 11.

After returning from the defrosting operation to the heating operation, a process occurs in which liquid refrigerant accumulated in the accumulator 14 of outdoor unit 10 is removed and re-accumulated in the indoor unit 20 again. Therefore, if the amount of liquid refrigerant accumulated in the accumulator 14 is large, the rise of heating capacity after returning from the defrosting operation to the heating operation will be slow. Therefore, the refrigerant accumulated in the indoor units 20a and 20b is retained in the indoor units 20a and 20b, so that it is not allowed to flow to the outdoor unit 10. This improves the rise of heating capacity after returning from the defrosting operation to the heating operation, and improves the heating capacity at low outdoor air temperatures.

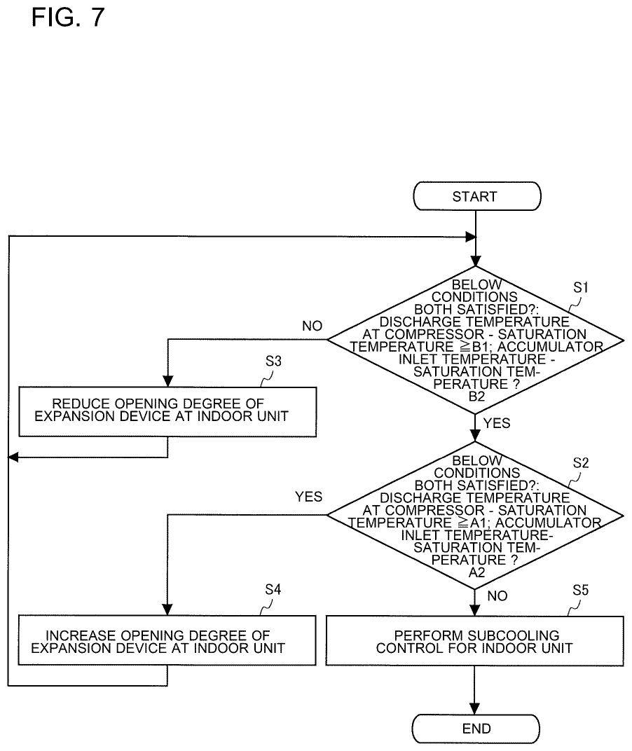

FIG. 7 is a flowchart showing the control process of the air-conditioning apparatus 100 according to the embodiment after returning from the defrosting operation to the heating operation. In the air-conditioning apparatus 100 of the embodiment, after returning from the defrosting operation to the heating operation, the control process shown in FIG. 7 is executed at every preset interval (e.g., once every 30 seconds), for several minutes (e.g., 10 minutes).

### (Step S1)

The controller 40 is configured to perform a first determining process to determine if a difference between the temperature detected by the discharge temperature detecting device 51 and the saturation temperature (condensing temperature) converted from the pressure detected by the discharge pressure detecting device 52 is greater than or equal to the preset first threshold value, B1 (compressor discharge temperature−saturation temperature (condensing temperature)≥B1), and a difference between the temperature detected by the inlet temperature detecting device 53 and the saturation temperature (evaporating temperature) converted from the pressure detected by the suction pressure detecting device 54 is greater than or equal to B2 (accumulator inlet temperature−saturation temperature (evaporating temperature)≥B2), which is a preset second threshold value. If the conditions of the first determining process is satisfied, the process proceeds to step S2, and if the condition of the first determining process is not satisfied, the process proceeds to step S3.

### (Step S2)

The controller 40 is configured to perform a second determining process to determine if a difference between the temperature detected by the discharge temperature detecting device 51 and the saturation temperature (condensing temperature) converted from the pressure detected by the discharge pressure detecting device 52 is equal to or greater than a preset third threshold value, A1 (>B1) (compressor discharge temperature−saturation temperature (condensing temperature)≥A1), and a difference between the temperature detected by the inlet temperature detecting device 53 and the saturation temperature (evaporating temperature) converted from the pressure detected by the suction pressure detecting device 54 is greater than or equal to A2 (>B2) (accumulator inlet temperature−saturation temperature (evaporating temperature)≥A2), which is a preset fourth threshold value. If the condition of the second determining process is satisfied, the process proceeds to step S4, and if the condition of the second determining process is not satisfied, the process proceeds to step S5.

### (Step S3)

The controller 40 reduces the opening degrees of the expansion devices 21a and 21b of the indoor units 20a and 20b on the assumption that an excessive amount of liquid refrigerant returns to outdoor unit 10. If an excessive amount of liquid refrigerant returns from the indoor units 20a and 20b to the outdoor unit 10, the liquid refrigerant accumulated in the accumulator 14 may overflow and liquid backflow to the compressor 11. This may cause a failure. After returning from defrosting operation to heating operation, a process occurs in which the liquid refrigerant accumulated in the accumulator 14 of the outdoor unit 10 is removed and re-accumulated in the indoor unit 20 again. Therefore, if the amount of liquid refrigerant accumulated in the accumulator 14 is large, the rise of heating capacity after returning from defrosting operation to heating operation will be slow. Therefore, if an excessive amount of liquid refrigerant returns from the indoor units 20a and 20b to the outdoor unit 10, the opening degrees of expansion devices 21a and 21b of indoor units 20a and 20b are reduced. By doing so, it is possible to prevent an excessive amount of liquid refrigerant from returning from the indoor units 20a and 20b to the outdoor unit 10 and to suppress the overflow of liquid refrigerant accumulated in the accumulator 14 and the liquid backflow to compressor 11. Furthermore, the rise of heating capacity after returning from defrosting operation to heating operation can be improved, and the heating capacity at a low outdoor air temperature can be improved.

### (Step S4)

The controller 40 increases the opening degrees of the expansion devices 21a and 21b of the indoor units 20a and 20b, assuming that the return of liquid refrigerant from the indoor units 20a and 20b to the outdoor unit 10 is insufficient. If the liquid return from the indoor units 20a and 20b to the outdoor unit 10 is insufficient, the pressure on the suction side of the compressor 11 decreases, which causes the suction pressure of the compressor 11 to decrease. The decrease of the suction pressure results in a decrease in the heating capacity. Therefore, when the liquid return from the indoor units 20a and 20b to the outdoor unit 10 is insufficient, increasing the opening degrees of the expansion devices 21a and 21b of the indoor units 20a and 20b lowers the pressure on the suction side and the suction density of the compressor 11, which can prevent the heating capacity from being lowered.

### (Step S5)

The controller 40 controls the subcooling at the outlets of the load-side heat exchangers 22a and 22b, assuming that the opening degrees of the expansion devices 21a and 21b of the indoor units 20a and 20b are the appropriate opening degrees. In other words, the opening degree of each of the expansion devices 21a and 21b is controlled so that the subcooling (degree of subcooling) at the outlet of each of the load-side heat exchangers 22a and 22b is at a preset value. Here, the subcooling at the outlet of each of the load-side heat exchangers 22a and 22b is the saturation temperature (condensing temperature) converted from the pressure detected by the discharge pressure detecting device 52−the temperature detected by the condenser outlet temperature detecting devices 55a and 55b (SC=saturation temperature (condensing temperature)−condenser outlet temperature).

The values of A1 and B1 above are the values depending on the compression ratio, e.g., A1=30 degrees C, B1=25 degrees C. A2 and B2 above are the values depending on which the superheat (degree of superheat) barely occurs at the inlet of the accumulator 14. For example, the value of A=5 degrees C, and the value of B2=3 degrees C.

The air-conditioning apparatus 100 according to the embodiment described above comprises the outdoor unit 10, the indoor units 20 a, 20b, the relay unit 30, the refrigerant circuit 101, the controller 40, the discharge temperature detecting device 51, the discharge pressure detecting device 52, the inlet temperature detecting device 53 and the suction pressure detecting device 54. The outdoor unit 10 includes the compressor 11, the flow switching device 12, the heat source-side heat exchanger 13, and the accumulator 14. The indoor units 20a and 20b include the expansion devices 21a and 21b, and the load-side heat exchangers 22a and 22b. The relay unit 30 is connected between the outdoor unit 10 and indoor units 20a and 20b and configured to switch flow of refrigerant depending on the operating status. In the refrigerant circuit 101, the outdoor unit 10, the relay unit 30 and the indoor units 20a and 20b are connected by pipes, and the refrigerant circulates. The controller 40 is configured to control the refrigerant circuit 101. The discharge temperature detecting device 51 detects the temperature of the refrigerant discharged from the compressor 11. The discharge pressure detecting device 52 detects the pressure of the refrigerant discharged from the compressor 11. The inlet temperature detecting device 53 detects the temperature of the refrigerant flowing into the accumulator 14, and the suction pressure detecting device 54 detects the pressure of the refrigerant suctioned into the compressor 11. The controller 40 switches the flow switching device 12 so that the refrigerant discharged from the compressor 11 flows into the heat source-side heat exchanger 13 and fully closes the valve 21 during the defrosting operation. After returning from the defrosting operation to the heating operation, the controller 40 performs a first determining process to determine whether the difference between the temperature detected by the discharge temperature detecting device 51 and the saturation temperature (condensing temperature) converted from the pressure detected by the discharge pressure detecting device 52 is equal to or greater than a first threshold, which is a preset value, and the difference between the temperature detected by the inlet temperature detecting device 53 and the saturation temperature (evaporating temperature) converted from the pressure detected by the suction pressure detecting device 54 is equal to or greater than the second threshold value, which is a preset value. If the conditions of the first determining process is not satisfied, the opening degree of the expansion device is reduced.

According to the air-conditioning apparatus 100 according to the embodiment, during the defrosting operation, the controller 40 switches the flow switching device 12 so that the refrigerant discharged from the compressor 11 flows into the heat source-side heat exchanger 13, and fully closes the expansion devices 21a and 21b. After returning from defrosting operation to heating operation, a first determining process is performed to determine whether an excessive amount of liquid refrigerant returns to the outdoor unit 10, and if the conditions of the first determining process are not met, the opening degrees of the expansion devices 21a and 21b are reduced. In this way, by fully closing expansion devices 21a and 21b of the indoor units 20a and 20b during the defrosting operation, liquid refrigerant accumulated in the indoor units 20a and 20b does not flow to the outdoor unit 10, the liquid backflow to the compressor 11 can be suppressed. Furthermore, if an excessive amount of liquid refrigerant returns from the indoor units 20a and 20b to the outdoor unit 10 after the apparatus's returning from the defrosting operation to the heating operation, reducing the opening degrees of the expansion devices 21a and 21b of the indoor units 20a and 20b prevents an excessive amount of liquid refrigerant from returning from the indoor units 20a and 20b to outdoor unit 10, thereby preventing liquid backflow to the compressor 11. Moreover, the rise of heating capacity after returning from the defrosting operation to heating operation can be improved, and the heating capacity at low outdoor air temperature can be improved.

In the air-conditioning apparatus 100 according to the embodiment, the controller 40 performs the first determining process, and if the conditions of the first determining process are satisfied, the controller 40 performs a second determining process to determine if: a difference between a temperature detected by the discharge temperature detecting device 153 and the saturation temperature (condensing temperature) converted from the pressure detected by the discharge pressure detecting device 52 is equal to or greater than the third threshold value, which is a preset value greater than the first threshold value; and a difference between a temperature detected by the inlet temperature detecting device 53 and the saturation temperature (evaporating temperature) converted from the pressure detected by the suction pressure detecting device 54 is greater than or equal to the fourth threshold value, which is a preset value greater than the second threshold value. If the condition of the second determining process is satisfied, the opening degrees of the expansion devices 21a and 21b are increased.

According to the air-conditioning apparatus 100 according to an embodiment, the first determining process is performed, and when the conditions of the first determining process is satisfied, a second determining process is performed to determine whether insufficient amount of liquid returns to the outdoor unit 10. If the condition of the second determining process is satisfied, the opening degree of the expansion devices 21a and 21b are increased. In other words, if the liquid return to the outdoor unit 10 is insufficient, increasing the opening degree of the expansion devices 21a and 21b of the indoor units 20a and 20b causes the pressure on the suction side to decrease. This reduces the suction density of the compressor 11 and prevents the heating capacity from decreasing.

In the air-conditioning apparatus 100 according to the embodiment, the controller 40 performs the control process including the first determining process and the second determining process at every preset interval for a preset time period, after returning from the defrosting operation to the heating operation.

According to the air-conditioning apparatus 100 according to an embodiment, the first determining process to determine if an excessive amount of liquid refrigerant returns to the outdoor unit 10 and the second determining process to determine whether liquid does not return enough to the outdoor unit 10 are performed at the above timing, thereby efficiently eliminating the excessive return of liquid refrigerant to the outdoor unit 10 and the insufficient return of liquid to the outdoor unit 10.

### REFERENCE SIGNS LIST

1: first main pipe, 2: second main pipe, 3: first connection pipe, 4: second connection pipe, 5a: first branch pipe, 5b: first branch pip, 6a: second branch pipe, 6b: second branch pipe, 7: connection pipe, 8: connection pipe, 9: relay pipe, 10: outdoor unit, 11: compressor, 12: flow switching device, 13: heat source-side heat exchanger, 14: accumulator, 15a: check valve, 15b: check valve, 15c: check valve, 15d: check valve, 20: indoor unit, 20a: indoor unit, 20b: indoor unit, 21a: expansion device, 21b: expansion device, 22a: load-side heat exchanger, 22b: load-side heat exchanger, 30: relay unit, 31 gas-liquid separator, 32 first expansion device, 33 second expansion device, 34: first valve, 34a: first valve, 34b: first valve, 35: second valve, 35a: second valve, 35b: second valve, 40: controller, 51: discharge temperature detecting device, 52 discharge pressure detecting device, 53: inlet temperature detecting device, 54: suction pressure detecting device, 55a: condenser outlet temperature detecting device, 55b: condenser outlet temperature detecting device, 100: air-conditioning apparatus, 101: refrigerant circuit

1. An air-conditioning apparatus comprising:
an outdoor unit including a compressor, a flow switching device, a heat source-side heat exchanger, and an accumulator;
an indoor unit including an expansion device and a load-side heat exchanger
a relay unit connected between the outdoor unit and the indoor unit, and configured to switch a flow of refrigerant depending on an operation state;
the outdoor unit, the relay unit, and the indoor unit being connected by pipes, to form a refrigerant circuit in which the refrigerant circulates,
a controller configured to control the refrigerant circuit;
a discharge temperature detecting device configured to detect a temperature of the refrigerant discharged from the compressor;
a discharge pressure detecting device configured to detect a pressure of the refrigerant discharged from the compressor;
an inlet temperature detecting device configured to detect the temperature of the refrigerant flowing into the accumulator, and
a suction pressure detecting device configured to detect the pressure of the refrigerant suctioned by the compressor,
the controller is configured to
upon defrosting operation, switch the flow switching device so that the refrigerant discharged from the compressor flows into the heat source-side heat exchanger and fully close the expansion device, and, after returning from the defrosting operation to the heating operation, perform a first determining process to determine if:
a difference between a temperature detected by the discharge temperature detecting device and a condensing temperature converted from a pressure detected by the discharge pressure detecting device is equal to or greater than a first threshold value, which is a preset value; and
a difference between a temperature detected by the inlet temperature detecting device and an evaporating temperature converted from a pressure detected by the suction pressure detecting device is equal to or greater than a second threshold value, which is a preset value, to determine if an excessive amount of liquid refrigerant returns to the outdoor unit, and,
if a condition of the first determining process is not satisfied, reduce an opening degree of the expansion device to prevent liquid backflow to the compressor.

2. The air-conditioning apparatus of claim 1, wherein
the controller is configured to
perform the first determining process, and when the condition of the first determining process is satisfied,
perform a second determination process to determine if: a difference between the temperature detected by the discharge temperature detecting device and the condensing temperature converted from the pressure detected by the discharge pressure detecting device is equal to or greater than a third threshold value, which is a preset value, greater than the first threshold value; and a difference between a temperature detected by the inlet temperature detecting device and the evaporating temperature converted from the pressure detected by the suction pressure detecting device is greater than or equal to a fourth threshold value, which is a value greater than the second threshold value to determine if an insufficient amount of liquid refrigerant is returning to the outdoor unit, and
increase an opening degree of the expansion device when a condition of the second determination process are satisfied to prevent heating capacity from decreasing.

3. The air-conditioning apparatus of claim 2, wherein
the controller is configured to perform the second determining process, and, if the condition of the second determining process is not satisfied, control the opening degree of the expansion device so that subcooling at an outlet of the load-side heat exchanger is at the preset value.

4. The air-conditioning apparatus of claim 3, wherein
the controller is configured to perform a control process including the first determining process and the second determining process at every preset interval, for a preset time period, after returning from the defrosting operation to the heating operation.
